(19) United States
(12) Patent Application Publication
(10) Pub. No.: US 2004/0058232 A1
(43) Pub. Date: Mar. 25, 2004

(54) Negative electrode for lithium battery and lithium battery comprising same

(75) Inventors: Yong-Tae Kim, Seoul (KR); Su-Suk Choi, Osan-city (KR); Yun-Suk Choi, Cheonan-city (KR); Kyoung-Hee Lee, Cheonan-city (KR)

Correspondence Address: McGuireWoods LLP, Tysons Corner, Suite 1800, 1750 Tysons Boulevard, McLean, VA, 22102-4215, US

(73) Assignee: Samsung SDI Co., Ltd.

(21) Appl. No.: 10/664,157

(22) Filed: Sep. 17, 2003

(30) Foreign Application Priority Data
Sep. 23, 2002 (KR) 2002-0057577

(51) Int. Cl. H01M 2/16; H01M 4/66; H01M 4/40

(52) U.S. Cl. 429/137; 429/246; 429/245; 429/212; 429/231.95

(57) ABSTRACT

A lithium negative electrode for a lithium battery have good cycle life and capacity characteristics. The lithium negative electrode comprises a lithium metal layer and a protective layer present on the lithium metal layer, where the protective layer includes an organosulfur compound. An organosulfur compound having a thiol terminal group is preferred since such a compound can form a complex with lithium metal to enable coating to be carried out easily. The organosulfur compound has a large number of S or N elements having high electronegativity to form a complex with lithium ions, so it renders lithium ions to be deposited relatively evenly on the lithium metal surface, reducing dendrite formation.

### CROSS REFERENCE TO RELATED APPLICATION

This application claims the benefit of Korean Patent Application No. 2002-57577 filed in the Korean Intellectual Property Office on Sep. 23, 2002, which is hereby incorporated by reference in its entirety for all purposes as if fully set forth herein.

### BACKGROUND OF THE INVENTION

1. Field of the Invention

The present invention relates to a negative electrode for a lithium battery, and more specifically, to a negative electrode for a lithium battery with excellent electrochemical characteristics.

1. Description of the Related Art

Trends toward more compact and lighter portable electronic equipment has resulted in a growing need to develop high performance and large capacity batteries for such portable electronic equipment. These batteries generate electric power by using materials capable of electrochemical reactions at the positive and negative electrodes of the battery. Battery performance characteristics include capacity of the battery, the cycle life, power capability, safety, and reliability. Factors that affect battery performance characteristics include the electrochemical properties and thermal stability of the active materials that participate in the electrochemical reactions at the positive and negative electrodes. Therefore, research to improve the electrochemical properties and thermal stability of the active materials at the positive and negative electrodes continues.

Among the active materials currently being used for negative electrodes of batteries, lithium metal provides both high capacity because it has a high electric capacity per unit mass and high voltage due to its relatively high electronegativity for a metal. However, since it is difficult to assure the safety of a battery using lithium metal, other materials that can reversibly deintercalate and intercalate lithium ions are being used extensively for the active material of the negative electrodes in lithium secondary batteries.

Other materials that can intercalate or deintercalate lithium ions include carbon-based materials such as crystalline carbon and amorphous carbon. The crystalline carbon includes graphite materials such as artificial graphite and natural graphite. Typical examples of amorphous carbon include soft carbon which is prepared by heat-treating pitch at 1000° C., and hard carbon which is prepared by carbonizing a polymer resin.

The voltage of a lithium secondary battery is determined by the electrochemical potential between the positive active material of a lithium-based metal oxide and the negative active material of a carbonaceous material. Artificial graphite has a high charge-discharge efficiency, but has a low discharge capacity. Natural graphite has a relatively high charge-discharge capacity, but has a low charge-discharge efficiency due to high reactivity with the electrolyte. Further, graphite has poor high-rate efficiency and cycle life characteristics due to the plate-shape physical structure of the natural graphite.

While there have been attempts to use the advantages of both artificial graphite and natural graphite, these attempts have not yet reached a satisfactory level.

When graphite is applied to a negative electrode, the potential of intercalation of lithium ions into graphite layers is lower than the potential when using an amorphous carbonaceous material or another metal oxide. Accordingly the potential difference between the negative electrode and positive electrode is larger when graphite is used than when amorphous carbonaceous material is used, resulting in the fabrication of a higher voltage battery. The graphite maintains a potential at a certain level during the intercalation of lithium ions, and the voltage flatness of the battery and coulomb efficiency of the first cycle are good. The coulomb efficiency refers to a ratio of intercalation and deintercalation of lithium ions in the negative electrode. Graphite has high coulomb efficiency since an amount of intercalation is nearly the same as that of deintercalation. However, graphite has a theoretical capacity of less than 372 mAh/g and an actual capacity of less than 300 mAh/g.

An amorphous carbonaceous material adopted for the negative electrode active material can realize higher capacity than graphite, but its voltage flatness is poor, its irreversible capacity is large, and its coulomb efficiency of the first cycle is low.

Efforts to obtain new carbonaceous materials having good electrochemical properties have been undertaken, but these materials typically fall short of exceeding the characteristics of lithium metal in terms of capacity characteristics.

In order to solve shortcomings of lithium metal, U.S. Pat. No. 6,025,094 discloses a negative electrode comprising an inorganic material such as lithium silicate coated on lithium metal, while U.S. Pat. No. 6,207,326 discloses a negative electrode comprising a film including nitrogen or a halogen element coated on lithium metal.

### SUMMARY OF THE INVENTION

Accordingly, the present invention is directed to a negative electrode for a lithium battery and a lithium battery that substantially obviates one or more of the problems due to limitations and disadvantages of the related art. The present invention includes a protective layer for the negative electrode where the protective layer may include one or more organosulfur compounds or polymers. The protective layer reduces the formation of dendrites on the metal electrode during charging which results in improved cycle life characteristics of the battery. Further, the protective layer reduces oxidation of the metal layer by inhibiting direct contact of moisture or oxygen in the air to the metal layer.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is cross-sectional view of a negative electrode according to an embodiment of the present invention.

FIG. 2 is a cross-sectional view of a prismatic lithium ion battery cell according to an embodiment of the present invention.

FIG. 3 illustrates a graph showing cycle life characteristics of cells including negative electrodes fabricated according to Examples 1 and 2, and a cell of Comparative Example 1.

### DETAILED DESCRIPTION OF THE PREFERRED EMBODIMENTS

Lithium metal as a negative active material provides both high capacity because it has a high electric capacity per unit mass, and high voltage due to a relatively low electronegativity. However, as charge-discharge proceeds, dendrites are formed resulting in short-circuits, possible explosions, and an abrupt deterioration of cycle life characteristics.

The present invention is directed improving the cycle life and capacity characteristics of a lithium battery. To achieve these and other advantages and in accordance with the purpose of the present invention, as embodied and broadly described, the present invention includes a negative electrode for a lithium battery comprising a lithium metal layer and a protective layer present on the lithium metal layer, where the protective layer includes an organosulfur compound.

In another aspect of the present invention, the invention includes a negative electrode for a lithium battery, where the negative electrode includes a lithium metal layer, a protective layer present on the lithium metal layer where the protective layer includes an organosulfur compound, an electron conductive polymer, and an ionic conductive polymer.

In another aspect of the present invention, the invention includes a method for fabricating a negative electrode for a lithium battery comprising the steps of adding an organosulfur compound to a solvent to prepare a slurry, and coating the lithium metal with the slurry to form an organosulfur compound-containing layer.

In still another aspect of the present invention, the invention includes a lithium battery comprising a positive electrode having a positive active material selected from the group consisting of a lithium-containing metal oxide, a lithium-containing calcogenide, a sulfur-based material, and a conductive polymer, a negative electrode having a lithium metal layer and a protective layer on the lithium metal where the protective layer includes an organosulfur compound, and an electrolyte.

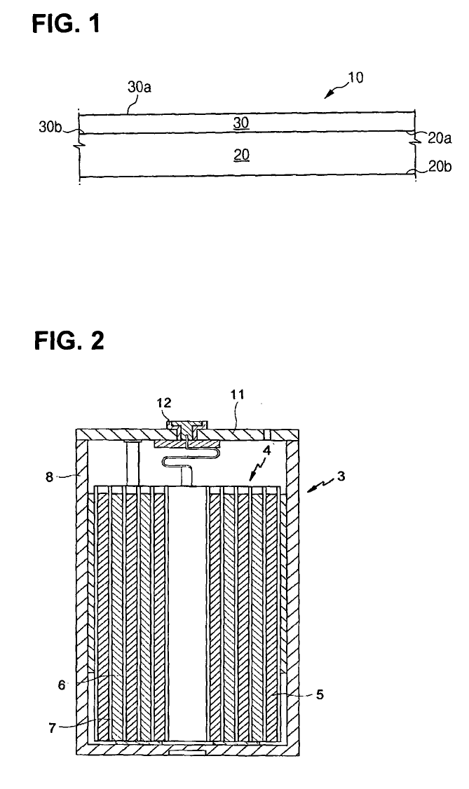

In the present invention, a protective layer that includes an organosulfur compound is present on the lithium metal, which stabilizes the surface of the lithium. A cross section of a lithium metal negative electrode is shown in FIG. 1. As shown in FIG. 1, the lithium metal negative electrode 10 comprises a lithium metal layer 20, and a protective layer 30 which includes the organosulfur compound present on the lithium metal layer 20. One surface 20a of the lithium metal layer 20 lies adjacent to one surface 30b of the protective layer 30. The protective layer 30 reduces the formation of dendrites on the lithium metal during charging to improve cycle life characteristics of the battery. Further, the protective layer 30 reduces oxidation of the lithium metal layer 20 by inhibiting the direct contact of moisture or oxygen in air to the lithium metal layer.

In accordance with an aspect of the present invention, the organosulfur compound may be in the form of a compound, monomer, dimer, trimer, oligomer, or a polymer. In certain embodiments, the organosulfur compound preferably contains a thiol functional group. The organosulfur compound may include, but is not limited to, 2,5-dimercapto-1,3,4-thiadiazole, bis(2-mercapto-ethyl)ether, N,N′-dimethyl-N,N′-dimercaptoethylene-diamine, N,N,N′,N′-tetramercapto-ethylenediamine, polyethyleneimine or its derivatives such as polyethylene imine sulfide or polyethylene imine polysulfide, 2,4,6-trimercaptotriazole, N,N′-dimercapto-piperazine, 2,4-dimercaptopyrimidine, 1,2-ethanedithiol, bis(2-mercapto-ethyl)sulfide, or derivative or mixtures thereof. An exemplary organosulfur compound includes 2,5-dimercapto-1,3,4-thiadiazole represented by the following formula 1:

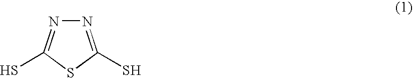

An organosulfur compound having a thiol terminal group is preferred since such a compound can form a complex with lithium metal to enable coating to be carried out easily. The organosulfur compound has a large number of S or N elements having a relatively high electronegativity that forms a complex with lithium ions. Accordingly, the organosulfur compound allows lithium ions to be deposited relatively evenly on the lithium metal surface resulting in the reduction of dendrite formation on the lithium metal surface of the electrode.

The protective layer 30 preferably includes the organosulfur compound in an amount ranging from about 50 to about 100 wt %, and more preferably from about 50 to about 70 wt %. When the amount of the organosulfur compound is less than about 50 wt %, the coating effect of the protective layer may not be realized sufficiently.

The protective layer 30 may further include an electron conductive polymer to provide electron conductivity and to facilitate cation transfer across the protective layer.

Examples of the electron conductive polymers may include, but are not limited to, poly(aniline), poly(p-phenylene), poly(thiophene), poly(3-alkylthiophene), poly(3-alkoxythiophene), poly(crown ether thiophene), poly(pyrrole), poly(N-alkylpyrrole), poly(pyridine), poly(alkylpyridine), poly(2,2′-bipyridine), poly(dialkyl-2,2′-bipyridine), poly(pyrimidine), poly(dihydrophenanthrene), poly(quinoline), poly(isoquinoline), poly(1,2,3-benzothiadiazole), poly(benzimidiazole), poly(quinoxaline), poly(2,3-diarylquinoxaline), poly(1,5-naphthyridine), poly(1,3-cyclohexadiene), poly(anthraquinone), poly(Z-methylanthraquinone), poly(ferrocene), poly(6,6′-biquinoline), and other similar polymers. The alkyl group may be a C₁ to C8 alkyl group, and the aryl group is C₆ to C₄₀ group. The electron conductive polymer wherein a hydrocarbon is substituted with a sulfon group can effectively facilitate cation transfer.

Conductive polymers may be classified according to their electric state. The conductive polymers may be classified as either an emeraldine base polymer or a doped polymer. Emeraldine base polymers are electrically neutral polymers while a doped polymer is typically charged. The emeraldine base polymer can be prepared by polymerizing monomers, or by dedoping a doped polymer. Dedoping can be carried out by adding a material that is capable of reacting with the doping material of the doped polymer, and then washing the product to obtain the emeraldine base polymer. The above polymer doped is prepared by polymerizing monomers under a solution atmosphere diluted with doping material. In addition, an emeraldine base polymer may be formed by dedoping a doped polymer, and then re-doping it with doping material. The polymer that is subjected to doping, dedoping, and re-doping has improved electroconductivity and solubility. The doped polymer loses electrons while bonding with a doping material, so it is charged with a positive charge (“+”), and it bonds with a doping material charged with a negative charge (“−”).

The doping material may include any material that can be charged with a negative charge “−” by attracting electrons from the polymer. There is no limitation concerning the type of the doping material. Examples of the doping material may include, but are not limited to, a halogen such as Cl₂, Br₂, I₂, ICl, ICl₃, IBr, or IF; a Lewis acid such as PF₅, AsF₅, SbF₅, BF₃, BCl₃, BBr₃, or SO₃; a proton acid such as HF, HCl, HNO₃, H₂SO₄, HClO₄, FSO₃H, ClSO₃H, CF₃SO₃H, or an amino acid; a transition metal compound such as FeCl₃, FeOCl, TiCl₄, ZrCl₄, HFCl₄, NbF₅, NbCl₅, TaCl₅, MoF₅, WF₆, WCl₆, UF₆, or LnCl₃ (Ln=lanthanoide); an electrolytic anion such as Cl⁻, Br⁻, I⁻, Cl₄⁻, PF₆⁻, AsF₆⁻, SbF₆⁻, or BF₄⁻; a sulfonic acid represented by R—SO₃H (where R is a C₁ to C₁₂ alkyl, a C₆ to C₁₂ aryl, or an aralkyl group), O₂, XeOF₄(NO₂+)(SbF₆⁻), (NO₂⁺)(SbF₆⁻), (NO₂⁺)(BF₄⁻), FSO₂OOSO₂F, AgClO₄, H₂IrCl₆, La(NO₃)₃).6H₂O, and other similar doping materials.

According to one embodiment, the electron conductive polymer may include a polyaniline represented by the following formula 2 which is substituted by sulfonic acid and doped with ClO₄⁻. This polymer can readily bonds with organosulfur compound and can effectively facilitate cation transfer.

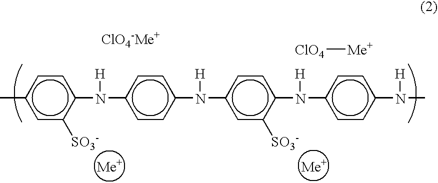

In formation 2, Me is an alkali metal, preferably lithium.

The size of the doping materials is not particularly limited as either bulky molecules as well as small anions. It is preferable to use doping materials that will expand the spacing of the electron conductive polymer such that the electron conductive polymer contacts the organosulfur compound effectively at a molecular level. Preferable large molecule doping materials include, but are limited to, dodecyl benzene sulfonic acid, p-toluene sulfonic acid, benzene sulfonic acid, and octylbenzene sulfonic acid.

The electron conductive polymer added in the protective layer 30 is preferably a polymer having a doping ratio of at least about 30%. If the doping ratio is less than 30%, conductivity of the polymer may be too low.

The electron conductive polymer is preferably added in the protective layer 30 in an amount of less than or equal to about 40 wt %, more preferably from about 20 to about 40 wt %. If the amount of the electron conductive polymer is too low, effective conductivity may not be realized. As the relative amount of the electron conductive polymer increases, the relative amount of the organosulfur compound decreases. To keep the relative amount of the organosulfur compound relatively high, it is preferable to keep the amount of the electron conductive polymer below about 40 wt %.

The protective layer 30 may further include an ionic conductive polymer having a low glass transition temperature and fragmental movement activity at room temperature to facilitate easy transfer of lithium ions. The ionic conductive polymer preferably has a glass transition temperature of less than about 20° C. Examples of the ionic conductive polymer may include, but are not limited to, poly(ethyleneoxide), poly(propyleneoxide), poly(ethylenesuccinate), poly(ethyleneadipate), poly(ethyleneimine), poly(epichlorohydrin), poly(β-propiolactone), poly(N-propylaziridine), poly(alkylenesulphide) (where the alkyl is a C₂ to C₆ aliphatic hydrocarbon), poly(ethyleneglycoldiacrylate), poly(prophyleneglycoldiacrylate), poly(ethyleneglycoldimethacrylate), poly(prophyleneglycoldimethacrylate), etc. The ionic conductive polymer may include a poly ethylene oxide having the following formula 3:

R₁0[CH₂CH₂0]ₙR₂ (3)

In formula 3, R₁ may range from about a C₁ to about a C₄ alkyl group and R₂ may range from about a C₁ to about a C₄ alkyl group. Preferably, the alkyl group may be substituted with an acrylate group.

The polyethylene oxide preferably has a weight average molecular weight ranging from about 10,000 to about 600,000.

The ionic conductive polymer is preferably added in the protective layer 30 at an amount sufficient to facilitate ion transfer. In certain embodiments, the amount of the ionic conductive polymer may range less than or equal to about 30 wt %, and preferably from about 10 to about 30 wt %. If the amount of the ionic conductive polymer is too low, the protective layer may not transfer lithium ions easily. As the relative amount of the ionic conductive polymer increases, the relative amount of the organosulfur compound decreases. In certain embodiments, the amount of the ionic conductive polymer is preferably less than about 30 wt %.

The process for preparing the protective layer containing the organosulfur compound for applying to the surface of the lithium metal will now be described. The organosulfur compound is added to a solvent to prepare a slurry. If an electron conductive polymer and/or an ion conductive polymer is to be used in the protective layer, they are added to the solvent along with the organosulfur compound.

In embodiments where the ionic conductive polymer is an acrylate-based polymer, the slurry preferably includes a cross-linking initiator and optionally a cross-linking facilitator to form an organosulfur compound-containing layer through the application of UV radiation or heat.

The cross-linking initiator may include, but is not limited to a diacyl peroxide such as dibenzoyl peroxide, succinic acid peroxide, dilauroyl peroxide, or didecanoyl peroxide; a dialkyl peroxide such as dicumyl peroxide, di-t-butyl peroxide, or 2,5-dimethyl-2,5-di-(t-butylperoxy)hexane; a peroxy ester such as α-cumyl peroxy neodecanoate, 1,1-dimethyl-3-hydroxybutyl peroxy-2-ethyl hexanoate, t-amylperoxy benzoate, or t-butyl peroxy pivalate; a tertiary alkyl hydroperoxide such as 2,5-dihydroperoxy-2,5-dimethylhexane, cumene hydroperoxide, or t-butyl hydroperoxide; a peroxy ketal such as 1,1-di-(t-amylperoxy)-cyclohexane, 2,2-di-(t-butyl peroxy)butane, or ethyl 3,3-di-(t-butylperoxy)-butylate; a peroxydicarbonate such as di(n-propyl) peroxy-dicarbonate, di(sec-butyl) peroxy-dicarbonate, di(2-ethyl hexyl)peroxy-dicarbonate; an azo compound such as azobis isobutyronitrile, and other similar cross-linking initiators.

The cross-linking facilitator may include, but is not limited to, triethylamine, tributylamine, riethanol amine, N-benzyldimethyl amine, or other cross-linking facilitators.

The solvent is not particularly limited as long as it provides an adequate slurry for coating the lithium metal. Suitable solvents may include, but are not limited to N-methyl pyrrolidone (NMP), and other similar solvents.

The organosulfur compound containing solvent is preferably stirred to provide a relatively homogeneous slurry. The slurry may further include other additives for the electrode such as a polyvinylidene fluoride (PVdF) binder, or other additives.

The prepared slurry is then applied to the lithium metal to form a protective layer containing the organosulfur compound. The method of coating the slurry on the lithium metal may include, but is not limited to, spin coating, dipping, spray coating, casting, and other coating methodologies. The coated lithium metal is preferably dried in a vacuum atmosphere followed by rolling it to form a lithium metal on which an organosulfur compound-containing layer is present as a protective layer.

According to another preferred embodiment, an organosulfur compound-containing protective layer may be formed on lithium metal by adding an organosulfur compound to a positive electrode and carrying out one or more charge-discharge cycles of the battery. In this process, a protective layer is formed in situ inside the lithium secondary battery during its fabrication. Therefore the forming process of the protective layer on the lithium metal is not necessarily carried out separately. In order to form an organosulfur compound-containing protective layer on lithium metal batteries, they are preferably charged and discharged at a current density of 0.1 to 10 mA/cm² in the voltage range of 2.0 to 4.5 V.

A negative electrode having the above described organosulfur containing protective layer can be used with all types of lithium batteries, including a lithium primary battery or a lithium secondary battery. Lithium secondary batteries may be classified as lithium ion batteries, lithium ion polymer batteries, and lithium polymer batteries according to the presence of a separator and kind of electrolyte used in the battery. The lithium secondary batteries may have a variety of shapes and sizes, including being cylindrical, prismatic, or coin-type batteries, and they may be thin film batteries or be rather bulky in size. Structures and fabricating methods for lithium ion batteries pertaining to the present invention are well known in the art.

While the present invention pertains to a wide variety of lithium ion batteries and configurations, a prismatic lithium ion battery cell will be described. A cross-sectional view of a prismatic lithium ion battery cell according to an embodiment of the present invention is illustrated in FIG. 2. As shown in FIG. 2, the lithium ion battery 3 is fabricated by the following process. An electrode assembly 4 is prepared by winding a positive electrode 5, a negative electrode 6 having an organosulfur containing protective layer as described above, and a separator 7 interposed between the positive electrode 5 and negative electrode 6. The electrode assembly 4 is placed into a battery case 8. An electrolyte is injected in the case 8, and the upper part of the battery case 8 is sealed. It is understood that other types of batteries can be constructed using the negative electrode of the present invention. Further, it is understood that, when the electrolyte is a solid electrolyte, the separator 7 and the electrolyte need not be included separately. In certain embodiments, the positive electrode may include a positive active material such as a lithium-containing metal oxide, a lithium-containing calcogenide, a sulfur-based material, a conductive polymer, or other similar material. The separator interposed between the positive and negative electrodes may include, but is not limited to a polyethylene, polypropylene, or polyvinylidene fluoride monolayered separator; a polyethylene/polypropylene double layered separator; a polyethylene/polypropylene/polyethylene three layered separator; or a polypropylene/polyethylene/polypropylene three layered separator. The electrolyte may include, but is not limited to an organic liquid electrolyte, a solid polymer electrolyte, a gel-type polymer electrolyte, a solid inorganic electrolyte, a molten inorganic electrolyte, or other similar electrolyte.

The present invention is further illustrated with reference to the following examples. The examples are provided to illustrate certain aspects of the invention and should not be interpreted as limiting the scope of the present invention.

Preparation of Lithium Metal Negative Electrode

### EXAMPLE 1

2 g of 2,5-dimercapto-1,3,4-thiadiazole (manufactured by Aldrich Company) as an organosulfur compound were dissolved in 5 g of N-methyl-2-pyrrolidone, and then 1 g of sulfonated polyaniline (manufactured by Aldrich Company) which was doped with Cl⁻ at a doping ratio of 35% was added with 0.5 g of polyethylene oxide (weight average molecular weight: 10,000, manufactured by Aldrich Company) to prepare a slurry for coating. The slurry was stirred at 5,000 rpm for 3 hours to obtain a homogenous slurry. To this slurry, isopropyl alcohol was added to control viscosity of the slurry. The slurry was coated with a spray gun on lithium metal to fabricate a lithium negative electrode as shown in FIG. 1.

### EXAMPLE 2

2 g of 2,5-dimercapto-1,3,4-thiadiazole (manufactured by Aldrich Company) as an organosulfur compound was dissolved in 5 g of N-methyl-2-pyrrolidone, and then 1 g of sulfonated polyaniline (manufactured by Aldrich Company) that was doped with dodecyl benzene sulfonic acid at a doping ratio of 35% was added with 0.5 g of polyethylene oxide (weight average molecular weight: 10,000, manufactured by Aldrich Company) to prepare a slurry for coating. The slurry was stirred at 5,000 rpm for 3 hours to obtain a homogenous slurry. To this slurry, isopropyl alcohol was added to control viscosity thereof. The slurry was coated with a spray gun on lithium metal to fabricate a lithium negative electrode as shown in FIG. 1.

### EXAMPLE 3

A lithium negative electrode was prepared by the same method as in Example 1, except that 2,4,6-trimercaptotriazole was used as an organosulfur compound.

### EXAMPLE 4

A lithium negative electrode was prepared by the same method as in Example 1, except that 1,2-ethanedithiole was used as an organosulfur compound.

Fabrication of Lithium Secondary Batteries

### EXAMPLE 5

Sublimed sulfur (manufactured by Aldrich Company) was added to isopropyl alcohol and ground in a ball-mill to obtain sulfur with an average particle size of 5. A conductive agent and a binder material were added and mixed while ball-milling in acetonitrile solvent to prepare a viscous slurry. As the conductive agent, super-P (manufactured by MMX carbon company) was added, and as the binder material, polyethylene oxide (number average molecular weight: 5,000,000, manufactured by Aldrich Company) was used. Sulfur, the conductive agent, and the binder material were used in a weight ratio of 60:20:20. The slurry that was dispersed homogeneously was poured on a carbon coated aluminum foil (REXAM) and coated using a doctor blade to obtain a positive electrode. Bicell-type lithium secondary battery cells were fabricated using the positive electrode and lithium negative electrodes prepared according to Examples 1-4 and Comparative Example 1 in a moisture-controlled glove box. A solution of IM LiSO₃CF₃ dissolved in 1,3-dioxolane/diglyme/sulforane/dimethoxyethane (50/20/10/20 of volume ratio) was used as an electrolyte.

### EXAMPLE 6

Sublimed sulfur (manufactured by Aldrich Company) was added to isopropyl alcohol and ground in a ball-mill to obtain sulfur with an average particle size of 5 μm. Then a conductive agent, a binder material, and an organosulfur compound were added and mixed while ball-milling in acetonitrile solvent to prepare a viscous slurry. As the conductive agent, super-P (manufactured by MMX carbon company) was added, and as the binder material, polyethylene oxide (number average molecular weight: 5,000,000, manufactured by Aldrich Company) was used. As the organosulfur compound, 2,5-dimercapto-1,3,4-thiadiazole (manufactured by Aldrich Company) was used. Sulfur, the organosulfur compound, the conductive agent, and the binder material were used in a weight ratio of 57:5:19:19. The slurry, which was dispersed homogeneously, was poured on a carbon coated aluminum foil (REXAM) and coated using a doctor blade to obtain a positive electrode. Bicell-type lithium secondary battery cells were fabricated using the positive electrode and uncoated lithium metal as a negative electrode in a under moisture-controlled glove box. A solution of 1M LiSO₃CF₃ dissolved in 1,3-dioxolane/diglyme/sulforane/dimethoxyethane (50/20/10/20 of volume ratio) was used as an electrolyte. The coin cell was charged at a current density of 0.2 mA/cm² and discharged at a current density of 0.1 mA/cm² in the voltage range of 2.3 to 4.0 V to form an organosulfur compound-containing protective layer on lithium metal.

### Comparative Example 1

A cell was fabricated by the same method as in Example 5, except that uncoated lithium metal was used as a negative electrode.

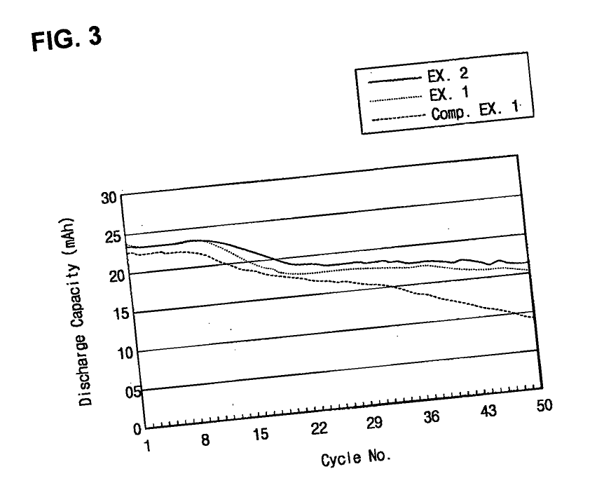

Cycle life characteristics of the cells according to Examples 5 and 6 and Comparative Example 1 were evaluated. The cells were charged until either condition of a charging time of 5.5 hours at a current density of 0.2 mA/cm² had elapsed, or a cut-off voltage of 2.8V was fulfilled, and they were then discharged at a current density of 0.1 mA/cm². The test results of cycle life characteristics according to cells including negative electrodes of Example 1 and 2 and the cell of Comparative Example 1 are shown in FIG. 3. As shown in FIG. 3, the cells including negative electrodes of Example 1 and 2 have better cycle life characteristics than that of Comparative Example 1.

As described above, using the negative electrode having a protective layer on its surface can solve deterioration of cycle life due to formation of dendrites during charging. Furthermore, the protective layer prevents direct contact of lithium metal with moisture and oxygen, resulting in prevention of oxidation of the lithium metal.

The present invention has been described in detail with reference to certain preferred embodiments. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A negative electrode for a lithium battery, comprising:
a lithium metal layer; and
a protective layer on the lithium metal layer, wherein the protective layer includes an organosulfur compound.

2. The negative electrode of claim 1, wherein the organosulfur compound is a thiol group-containing organosulfur compound.

3. The negative electrode of claim 1, wherein the organosulfur compound is a monomer, dimer, trimer, oligomer, or a polymer.

4. The negative electrode of claim 1, wherein the organosulfur compound is selected from the group consisting of 2,5-dimercapto-1,3,4-thiadiazole, bis(2-mercapto-ethyl)ether, N,N′-dimethyl-N,N′-dimercaptoethylene-diamine, N,N,N′,N′-tetramercapto-ethylenediamine, polyethyleneimine, polyethyleneimine derivatives, 2,4,6-trimercaptotriazole, N,N′-dimercapto-piperazine, 2,4-dimercaptopyrimidine, 1,2-ethanedithiol, bis(2-mercapto-ethyl)sulfide, and mixtures thereof.

5. The negative electrode of claim 1, wherein the organosulfur compound is in an amount ranging from about 50 to about 100 wt % of the protective layer.

6. The negative electrode of claim 1, wherein the protective layer further comprises an electron conductive polymer to provide electron conductivity and for facilitation of cation transfer.

7. The negative electrode of claim 6, wherein the electron conductive polymer is selected from the group consisting of poly(aniline), poly(p-phenylene), poly(thiophene), poly(3-alkylthiophene), poly(3-alkoxythiophene), poly(crowneherthiophene), poly(pyrrole), poly(N-alkylpyrrole), poly(pyridine), poly(alkylpyridine), poly(2,2′-bipyridine), poly(dialkyl-2,2′-bipyridine), poly(pyrimidine), poly(dihydrophenanthrene), poly(quinoline), poly(isoquinoline), poly(1,2,3-benzothiadiazole), poly(benzimidiazole), poly(quinoxaline), poly(2,3-diarylquinoxaline), poly(1,5-naphthyridine), poly(1,3-cyclohexadiene), poly(anthraquinone), poly(Z-methylanthraquinone), poly(ferrocene), and poly(6,6′-biquinoline).

8. The negative electrode of claim 6, wherein the electron conductive polymer is an emeraldine base polymer.

9. The negative electrode of claim 6, wherein the electron conductive polymer is a doped polymer.

10. The negative electrode of claim 9, wherein the doped polymer is prepared by reaction with a doping material, the doping material being selected from the group consisting of a halogen, a Lewis acid, a proton acid, a transition metal compound, an electrolytic anion, a sulfonic acid, O₂, XeOF₄(NO₂⁺)(SbF₆⁻), (NO₂⁺)(SbCl₆⁻), (NO₂⁺)(BF₄⁻), FSO₂OOSO₂F, AgClO₄, H₂IrCl₆, and La(NO₃)₃.6H₂O.

11. The negative electrode of claim 9, wherein the doped polymer is prepared by reaction with a doping material, the doping material being a halogen selected from the group consisting of Cl₂, Br₂, I₂, ICl, ICl₃, IBr, and IF.

12. The negative electrode of claim 9, wherein the doped polymer is prepared by reaction with a doping material, the doping material being a Lewis acid selected from the group consisting of PF₅, AsF₅, SbF₅, BF₃, BCl₃, BBr₃, and SO₃.

13. The negative electrode of claim 9, wherein the doped polymer is prepared by reaction with a doping material, the doping material being a proton acid selected from the group consisting of HF, HCl, HNO₃, H₂SO₄, HClO₄, FSO₃H, ClSO₃H, CF₃SO₃H, and an amino acid.

14. The negative electrode of claim 9, wherein the doped polymer is prepared by reaction with a doping material, the doping material being a transition metal compound selected from the group consisting of FeCl₃, FeOCl, TiCl₄, ZrCl₄, HFCl₄, NbF₅, NbCl₅, TaCl₅, MoF₅, WF₆, WCl₆, UF_{6,} and LnCl₃ (Ln=lanthanoide)

15. The negative electrode of claim 9, wherein the doped polymer is prepared by reaction with a doping material, the doping material being an electrolytic anion selected from the group consisting of Cl⁻, Br⁻, I⁻, Cl₄⁻, PF₆⁻AsF₆⁻, SbF₆⁻, and BF₄.

16. The negative electrode of claim 9, wherein the doped polymer is prepared by reaction with a doping material, the doping material being a sulfonic acid having the formula R-SO₃H, where R is selected from the group consisting of a C₁ to C₁₂ alkyl, a C₆ to C₁₂ aryl, and an aralkyl group.

17. The negative electrode of claim 9, wherein the doped polymer is prepared by reaction with a doping material, the doping material being selected from the group consisting of doceyl benzene sulfonic acid, p-toluene sulfonic acid, benzene sulfonic acid, and octylbenzene sulfonic acid.

18. The negative electrode of claim 6, wherein the electron conductive polymer is a polymer having a doping ratio of at least about 30%.

19. The negative electrode of claim 6, wherein the electron conductive polymer is added in the protective layer in an amount of less than or equal to about 40 wt % of the protective layer.

20. The negative electrode of claim 1, wherein the protective layer further comprises an ionic conductive polymer to help facilitate transfer of lithium ions.

21. The negative electrode of claim 20, wherein the ionic conductive polymer is selected from the group consisting of poly(ethyleneoxide), poly(propyleneoxide), poly(ethylenesuccinate), poly(ethyleneadipate), poly(ethyleneimine), poly(epichlorohydrin), poly(β-propiolactone), poly(N-propylaziridine), poly(alkylenesulphide) where the alkylene is a C₂ to C₆ aliphatic hydrocarbon, poly(ethyleneglycoldiacrylate), poly(prophyleneglycoldiacrylate), poly(ethyleneglycoldimethacrylate), and poly(prophyleneglycoldimethacrylate).

22. The negative electrode of claim 21, wherein the ionic conductive polymer has a weight average molecular weight ranging from about 10,000 to about 600,000.

23. The negative electrode of claim 20, wherein the ionic conductive polymer is added in the protective layer at an amount of less than or equal to about 30 wt %.

24. A negative electrode for a lithium battery, comprising:
a lithium metal layer; and
a protective layer on the lithium metal layer, wherein the protective layer includes an organosulfur compound, an electron conductive polymer, and an ionic conductive polymer.

25. The negative electrode of claim 24, wherein the protective layer comprises the organosulfur compound in an amount ranging from about 50 to about 70 wt %, the electron conductive polymer in an amount ranging from about 20 to about 40 wt %, and the ionic conductive polymer in an amount ranging from about 10 to about 30 wt % of the protective layer.

26. A method for fabricating a negative electrode for a lithium battery, the method comprising the steps of:
adding an organosulfur compound to a solvent to prepare a slurry; and
coating the slurry on lithium metal to form an organosulfur compound-containing layer.

27. The method for fabricating a negative electrode of claim 26 further comprising the step of adding an electron conductive polymer and an ionic conductive polymer to the solvent.

28. The method for fabricating a negative electrode of claim 27, wherein the electron conductive polymer is selected from the group consisting of poly(aniline), poly(p-phenylene), poly(thiophene), poly(3-alkylthiophene), poly(3-alkoxythiophene), poly(crowneherthiophene), poly(pyrrole), poly(N-alkylpyrrole), poly(pyridine), poly(alkylpyridine), poly(2,2′-bipyridine), poly(dialkyl-2,2′-bipyridine), poly(pyrimidine), poly(dihydrophenanthrene), poly(quinoline), poly(isoquinoline), poly(1,2,3-benzothiadiazole), poly(benzimidiazole), poly(quinoxaline), poly(2,3-diarylquinoxaline), poly(1,5-naphthyridine), poly(1,3-cyclohexadiene), poly(anthraquinone), poly(Z-methylanthraquinone), poly(ferrocene), and poly(6,6′-biquinoline).

29. The method for fabricating a negative electrode of claim 27, wherein the ionic conductive polymer is selected from the group consisting of poly(ethyleneoxide), poly(propyleneoxide), poly(ethylenesuccinate), poly(ethyleneadipate), poly(ethyleneimine), poly(epichlorohydrin), poly(β-propiolactone), poly(N-propylaziridine), poly(alkylenesulphide) poly(ethyleneglycoldiacrylate), poly(prophyleneglycoldiacrylate), poly(ethyleneglycoldimethacrylate), and poly(prophyleneglycoldimethacrylate).

30. The method for fabricating a negative electrode of claim 27 further comprising the step of adding a cross-linking initiator selected from the group consisting of diacyl peroxide dialkyl, peroxide peroxy ester, tertiary alkyl hydroperoxide, peroxy ketal, peroxydicarbonate, and an azo compound where the ionic conductive polymer is an acrylate-based polymer.

31. The method for fabricating a negative electrode of claim 27, further comprising the step of adding a cross-linking initiator selected from the group consisting of dibenzoyl peroxide, succinic acid peroxide, dilauroyl peroxide, didecanoyl peroxide, dicumyl peroxide, di-t-butyl peroxide, 2,5-dimethyl-2,5-di-(t-butylperoxy)hexane, α-cumyl peroxy neodecanoate, 1,1-dimethyl-3-hydroxybutyl peroxy-2-ethyl hexanoate, t-amylperoxy benzoate, t-butyl peroxy pivalate, 2,5-dihydroperoxy-2,5-dimethylhexane, cumene hydroperoxide, t-butyl hydroperoxide, 1,1-di-(t-amylperoxy)-cyclohexane, 2,2-di-(t-butyl peroxy)butane, ethyl 3,3-di-(t-butylperoxy)-butylate, di(n-propyl) peroxy-dicarbonate, di(sec-butyl) peroxy-dicarbonate, di(2-ethyl hexyl)peroxy-dicarbonate, and azobis isobutyronitrile.

32. The method for fabricating a negative electrode of claim 27, wherein the ionic conductive polymer is an acrylate-based polymer, and wherein the slurry further comprises a cross-linking facilitator.

33. The method for fabricating a negative electrode of claim 32, wherein the cross-linking facilitator is selected from the group consisting of triethylamine, tributylamine, riethanol amine, and N-benzyldimethyl amine.

34. A method for fabricating a negative electrode for a lithium battery, comprising the steps of:
adding an organosulfur compound to a positive electrode; and
performing at least one charge and discharge cycle for the battery having a negative electrode, thereby forming a protective layer on a negative.

35. A lithium battery, comprising
a positive electrode including a positive active material selected from the group consisting of a lithium-containing metal oxide, a lithium-containing calcogenide, a sulfur-based material, and a conductive polymer;
a negative electrode comprising a lithium metal layer, and a protective layer on the lithium metal layer, wherein the protective layer includes an organosulfur compound; and
an electrolyte between the positive and negative electrodes.

36. The lithium battery of claim 35, wherein the lithium battery is a lithium primary battery.

37. The lithium battery of claim 35, wherein the lithium battery is a lithium secondary battery.

38. The lithium battery of claim 35, wherein the electrolyte comprises a mixed organic solvent of 1,3-dioxolane, diglyme, sulforane, and dimethoxyethane.
